(19) United States
(12) Patent Application Publication
(10) Pub. No.: US 2025/0347475 A1
(43) Pub. Date: Nov. 13, 2025

(54) IMPROVED HEAT EXCHANGER DEVICE FOR AN AIRCRAFT TURBOMACHINE

(71) Applicant: SAFRAN, Paris (FR)

(72) Inventors: Samer MAALOUF, Moissy-Cramayel (FR); Ephraïm TOUBIANA, Moissy-Cramayel (FR)

(73) Assignee: SAFRAN, Paris (FR)

(21) Appl. No.: 18/868,459

(22) PCT Filed: May 19, 2023
(86) PCT No.: PCT/FR2023/050720

§ 371 Date: Nov. 22, 2024

(30) Foreign Application Priority Data
May 24, 2022 (FR) FR2204956

(51) Int. Cl. F28D 21/00; F28F 9/02

(52) U.S. Cl. CPC F28D 21/0001; F28F 9/02; F28D 2021/0021; F28D 2021/0026; F28F 2009/0287; F28F 2009/0295

(57) ABSTRACT

A device including a heat exchanger body, an upstream hot-fluid header attached to the heat exchanger body and configured to collect a first fluid at a first temperature and to feed it to the heat exchanger body, an upstream cold-fluid header attached to the heat exchanger body and configured to collect a second fluid at a second temperature lower than the first temperature and to feed it to the heat exchanger body, at least the upstream hot-fluid header including a double wall forming a peripheral cavity surrounding a main cavity configured to receive a main flow of the first fluid, the peripheral cavity being configured to receive a secondary flow of the first fluid or of the second fluid.

### TECHNICAL FIELD

The present disclosure relates to a heat exchanger device for an aircraft turbomachine, especially a turboprop or a turbojet, for example. The present disclosure also relates to a turbomachine comprising such a heat exchanger device.

### PRIOR ART

Thermal exchangers, or heat exchangers, are utilised in aircraft turbomachines to meet various needs, for example hot air/gas exchangers which recover hot gases from the nozzle outlet to heat air entering the combustion chamber, so-called “intercooler” air/air exchangers for cooling hot inter-compressor air with ambient air, nozzle heat exchangers for reheating of cryogenic fuel, or heat exchangers for ambient air cooling of air collected from the inter-compressor and intended for delivery to the cabin air conditioning system.

FIG. 1 schematically illustrates a sectional frontal view of a heat exchanger device 1′ according to the prior art, of cross-current type, comprising a first current 10 known as “hot current”, and a second current 20 known as “cold current”. In fact, as is known, heat exchangers used for the above applications involve a hot fluid at high temperature, generally a compressible fluid in the gaseous state having a temperature varying between 400° C. and 1000° C., and a cold fluid at lower temperature, generally between −150° C. and 400° C.

Typically, heat exchangers comprise headers at inlet and/or outlet of a heat exchanger body 30, ensuring the distribution of hot and cold fluids at inlet and/or outlet of the heat exchanger body. In this way, from upstream to downstream (according to the direction of flow of the hot fluid) the hot current 10 comprises an upstream hot-fluid header 12, channels of the heat exchanger body 30, and a downstream hot-fluid header 14. The upstream hot-fluid header 12 is configured to collect a first fluid, known as “hot fluid” in a separate section of the turbomachine (not illustrated). For example, the upstream hot-fluid header 12 can collect the hot gases as they exit from the low-pressure turbine and convey them to the heat exchanger body 30, in which the cold fluid also circulates.

It is therefore understood that the upstream hot-fluid header 12 extends between a first upstream end 12a for collecting the high-temperature hot fluid, and a second downstream end 12b attached to the heat exchanger body 30, via which the hot fluid is injected into the channel or channels of the heat exchanger body 30. The downstream hot-fluid header 14 also extends between a first upstream end 14a attached to the heat exchanger body 30 and via which the hot fluid which has circulated in the heat exchanger body 30 is recovered, and a downstream end 14b communicating with a separate section (not illustrated) of the turbomachine.

Similarly, from upstream to downstream (according to the direction of flow of the cold fluid), the cold current 20 comprises an upstream cold-fluid header 22, channels of the heat exchanger body 30, and a downstream cold-fluid header 24. The upstream cold-fluid header 22 is configured to collect a second fluid, known as “cold fluid” in a separate section of the turbomachine (not illustrated), for example in the secondary air flow path.

It is understood that the upstream cold-fluid header 22 extends between a first upstream end 22a for collecting the low-temperature cold fluid, and a second downstream end 22b attached to the heat exchanger body 30, via which the cold fluid is injected into the channel or the channels of the heat exchanger body 30. The downstream cold-fluid header 24 also extends between a first upstream end 24a attached to the heat exchanger body 30 and via which the cold fluid which has circulated in the heat exchanger body 30 is recovered, and a downstream end 24b communicating with a separate section (not illustrated) of the turbomachine.

The heat exchanger body 30 (or exchanger core) is the piece in which actual heat exchanges occur between the hot fluid and the cold fluid. It is therefore understood that the heat exchanger body 30 comprises one or more channels in which the hot fluid circulates, and one or more channels in which the cold fluid circulates, the heat transfers between these two fluids taking place through the walls of these different channels. In the case of a cross-current exchanger, the channels in which the cold fluid circulates are perpendicular to the channels in which the hot fluid circulates, these different channels being able to be superposed on each other.

However, these exchangers are subject to substantial thermal loads. Thermal dilation/contraction of the body (or core) of the exchanger 30 and the headers is caused at each engine cycle, with considerable thermal transients linked especially to when the engine is started and stopped. These loads especially cause substantial restrictions in the region of the junctions between the headers 12, 14, 22, 24 and the heat exchanger body 30. In the case of the cross-current exchanger 1′ in particular, there are four junction zones a, b, c, d between the downstream ends 12b, 22b of the upstream hot and cold-fluid header 12, 22 and the heat exchanger body 30, and between the upstream ends 14a, 24a of the downstream hot and cold-fluid header 14, 24 and the heat exchanger body 30. In the case of exchangers having headers of rectangular cross-section, these junction zones between the ends of the headers and the heat exchanger body are straight contact lines.

By way of repetition of the thermal cycles, these restrictions can lead to the formation of cracks in the overall heat exchanger body/headers, in particular in the junction zones a, b, c, d. These cracks known as thermal fatigue can themselves cause leaks and lead to the assembly fracturing, considerably reducing the service life of the exchanger. The mechanical characteristics of the walls of the headers can also be damaged when the temperature of the hot fluid circulating in the header is greater than the admissible temperature of the wall (for example 100 K for a wall made of stainless steel, or 500 K for a wall made of aluminium).

It is evident inversely that the walls of the heat exchanger body 30 are less impacted. In fact, because thermal exchanges between the hot fluid and the cold fluid mainly take place in the heat exchanger body 30, the temperature of the walls in the body of the exchanger is between that of the hot fluid and that of the cold fluid.

A known solution consists of adding to the headers flexible sections or gussets allowing extension and retractation of the header/heat exchanger body assembly. This reduces stresses on the supports of the assembly, and consequently reduces the risk of deformation of the exchanger. However, this type of device is difficult to implement in terms of operability and maintenance, has a high cost, and does not satisfactorily meet the problem mentioned above linked to the occurrence of cracks, in particular in the zones of junctions between the headers and the heat exchanger body.

There is therefore a need for a heat exchanger device which limits, or even eliminates problems linked on the one hand to thermal fatigue, and on the other hand to the mechanical strength of the headers.

### DISCLOSURE OF THE INVENTION

The present disclosure relates to a heat exchanger device for aircraft turbomachine, comprising a heat exchanger body, an upstream hot-fluid header attached to the heat exchanger body and configured to collect a first fluid at a first temperature and to feed it to the heat exchanger body, an upstream cold-fluid header attached to the heat exchanger body and configured to collect a second fluid at a second temperature lower than the first temperature, and to feed it to the heat exchanger body, at least the upstream hot-fluid header comprising a double wall forming a peripheral cavity surrounding a main cavity configured to receive a main flow of the first fluid, the peripheral cavity being configured to receive a secondary flow of the first fluid or of the second fluid.

In the present disclosure, the terms “upstream” and “downstream” are defined relative to the direction of flow of fluids in the different currents of the heat exchanger device, that is, the “hot” and “cold” currents. More specifically, the first fluid flows in the heat exchanger device according to its direction of flow, from upstream to downstream, in the upstream hot-fluid header in a first instance, then in the heat exchanger body, and finally in the downstream hot-fluid header to be defined later. In the same way the second fluid flows from upstream to downstream, in the upstream cold-fluid header in a first instance, then in the heat exchanger body, and finally in the downstream cold-fluid header to be defined later.

In the present disclosure, it is understood that the double wall of the upstream hot-fluid header comprises two walls relatively close to each other, without being in contact with each other. The resulting spacing between the two walls of this double wall forms a peripheral cavity surrounding the main cavity. It is evident that the main cavity conveys the first fluid collected in the turbomachine to the heat exchanger body by means of a main flow.

In addition, a fraction of the first fluid or of the second fluid can flow in the peripheral cavity, this fraction forming a secondary flow at the periphery of the main flow. Consequently, the first high-temperature fluid flowing into the main cavity is not separated from the exterior of the header, at ambient temperature, by a single wall, but by a double wall, by the peripheral cavity and by the secondary flow in this peripheral cavity.

This configuration lessens heat transfers by distributing the latter in the two walls of the header and in the secondary flow, and therefore limiting the risk of cracks occurring in these walls, especially in the region of the junction between the upstream hot-fluid header and the heat exchanger body.

In some embodiments, the device comprises a downstream cold-fluid header attached to the heat exchanger body and configured to collect the second fluid flowing from the heat exchanger body, the upstream hot-fluid header being configured to collect a fraction of the second fluid flowing into the upstream cold-fluid header, and to feed said fraction to the downstream cold-fluid header by means of the peripheral cavity.

According to this configuration, whereas the majority of the second fluid flows from upstream to downstream in the upstream cold-fluid header, in the heat exchanger body, then in the downstream cold-fluid header, a smaller fraction of the second fluid does not flow in the heat exchanger body, but is diverted to the upstream hot-fluid header, more specifically in the peripheral cavity formed by the double wall of said upstream hot-fluid header. After flowing into the peripheral cavity, this fraction of the second fluid is then reinjected in the downstream cold-fluid header, downstream of the heat exchanger body.

This flow of the second fluid, colder than the first fluid in the peripheral cavity, accordingly locally cools the wall situated to the side of the first fluid, in particular in the region of the junctions between the header and the heat exchanger body, these junctions being particularly stressed thermally. Consequently, while the turbomachine is operating, the upstream hot-fluid header undergoes lower temperature variations, effectively reducing or even eliminating the formation of cracks, but also improving its mechanical strength. In this way, the double wall itself acts as a heat exchanger, reheating this fraction of the second fluid and cooling the wall of the upstream hot-fluid header.

In some embodiments, the peripheral cavity comprises at least one inlet section opening in a main cavity of the upstream cold-fluid header, the inlet section being configured to collect the fraction of the second fluid and being arranged at a first junction between the upstream cold-fluid header, the upstream hot-fluid header and the heat exchanger body.

It is understood that the inlet section can be an opening formed in the junction between the upstream cold-fluid header, the upstream hot-fluid header and the heat exchanger body, placing the main cavity of the upstream cold-fluid header in fluid communication with the peripheral cavity of the upstream hot-fluid header. In this way, as a function of the dimensions of the inlet section, a small fraction of the second fluid flowing into the upstream cold-fluid header can enter the peripheral cavity of the upstream hot-fluid header by means of this inlet section. Placing the inlet section in the region of this junction boosts the heat exchanges between the second fluid and the wall of the upstream hot-fluid header at this site, limiting the risk of cracks at this junction.

In some embodiments, the peripheral cavity comprises at least one outlet section opening in a main cavity of the downstream cold-fluid header, the outlet section being configured to inject the fraction of the second fluid flowing into the peripheral cavity into the downstream cold-fluid header, and being arranged at a second junction between the downstream cold-fluid header, the upstream hot-fluid header and the heat exchanger body.

In the same way as for the inlet section, it is understood that the outlet section can be an opening formed in the junction between the upstream hot-fluid header, the downstream cold-fluid header and the heat exchanger body, placing the main cavity of the downstream cold-fluid header in fluid communication with the peripheral cavity of the upstream hot-fluid header. In this way, the fraction of the second fluid introduced via the inlet section and flowing into the peripheral cavity can be reinjected into the downstream cold-fluid header by means of the outlet section. Arranging the outlet section in the region of this junction increases heat exchanges between the second fluid and the wall of the upstream hot-fluid header at this site, and consequently limits the risk of cracks at this junction.

In some embodiments, the upstream and downstream hot-fluid headers and the upstream and downstream cold-fluid headers have a rectangular cross-section.

In this configuration, the first junction (and the second junction) between the upstream cold-fluid header (and the downstream cold-fluid header), the upstream hot-fluid header and the heat exchanger body is a linear junction, the inlet section and the outlet section extending linearly over at least part of these junctions.

By way of alternative, the upstream and downstream hot-fluid headers, and the upstream and downstream cold-fluid headers have a circular cross-section, the first and the second junction extending in an arc of a circle, the inlet section and the outlet section extending over an angular sector of between 20° and 180°.

The inlet section and the outlet section are preferably identical. In addition, the form of the headers is not limiting, as other geometric forms (for example elliptical) are possible.

In some embodiments, the upstream hot-fluid header comprises fins extending on the one hand longitudinally in a direction of flow of the first fluid in the main cavity, and extending on the other hand from one of the two walls of the double wall to the other of the two walls, inside the peripheral cavity.

It is understood that the fins are walls extending vertically relative to one of the two walls of the double wall, in other words perpendicularly to the latter, in the direction of the other of the two walls, but without any contact with this other wall. The fins also extend longitudinally, that is, from upstream to downstream. It is evident that these fins preferably extend from the internal wall of the double wall. Because these fins are arranged in the peripheral cavity and are therefore immersed in the fraction of the second fluid flowing into said cavity they improve heat transfers by increasing the exchange surface with the second fluid, and therefore further lower the wall temperature of the upstream hot-fluid header.

In some embodiments, the fins extend on the one hand longitudinally over a portion of a length of the upstream hot-fluid header, and extend on the other hand over the entire height of a space separating the two walls of the double wall.

Contrary to the preceding configuration, the fins extend over the entire height of the space separating the two walls of the double wall by being in contact with these two walls. This configuration further improves heat transfers by further increasing the exchange surface with the second fluid, and accordingly further lowers the wall temperature of the upstream hot-fluid header.

In some embodiments, a wall of the downstream hot-fluid header and of the downstream cold-fluid header comprise a flexible section, configured to allow a longitudinal deformation of the downstream hot-fluid header and of the downstream cold-fluid header. The flexible section can be a gusset which can be extended or retracted in the manner of an accordion section of a straw, consequently absorbing the dilations of the headers.

The flexible sections allow extension and retraction of the headers/heat exchanger body assembly. In addition to the advantages obtained by the double wall, the flexible sections therefore reduce stresses on the supports of this assembly, and consequently lower the risk of deformation of the assembly.

In some embodiments, the upstream hot-fluid header comprises an intermediate wall arranged in the peripheral cavity, and separating the fraction of the second fluid collected in the upstream cold-fluid header into a secondary internal flow and a secondary external flow.

In other terms, the intermediate wall divides the peripheral cavity into two cavities, in which the secondary internal flow and the secondary external flow respectively circulate. In the same way, the fraction of the second fluid collected in the upstream cold-fluid header is divided into two flows, specifically the secondary internal flow and the secondary external flow.

It is therefore understood that the secondary internal flow occurs between the internal wall separating the peripheral cavity of the main cavity of the upstream hot-fluid header and the intermediate wall. In the same way, the secondary external flow occurs between the external wall separating the peripheral cavity of the exterior of the upstream hot-fluid header, and the intermediate wall. Separating the fraction of the second fluid collected improves the homogenisation of the temperature of the walls of the upstream hot-fluid header, and better distributes heat transfers.

In some embodiments, the fraction of the second fluid collected in the upstream cold-fluid header is between 0.5 and 5% of the flow rate of the second fluid flowing into the upstream cold-fluid header.

These values produce the effects of cooling of the temperature of the walls of the upstream hot-fluid header as mentioned above, and limit any impact on the main flow of the second fluid used for heat transfers with the first fluid in the heat exchanger body.

In some embodiments, the device comprises a downstream hot-fluid header attached to the heat exchanger body, configured to collect the first fluid flowing from the heat exchanger body, comprising a double wall forming a peripheral cavity, and configured to collect a fraction of the second fluid flowing into the upstream cold-fluid header, and to feed said fraction to the downstream cold-fluid header by means of the peripheral cavity.

In this configuration, the upstream hot-fluid header and the downstream fluid header each comprise a double wall, and a fraction of the second fluid is collected to flow in the cavity of each of these headers. The fraction of the second fluid is preferably diverted into the peripheral cavity of the downstream hot-fluid header by means of an inlet section, and is reinjected into the downstream cold-fluid header by means of an outlet section. The technical effects described hereinabove in reference to the upstream hot-fluid header can also be obtained for the downstream hot-fluid header.

It is evident that the fraction of the second fluid collected and diverted in the peripheral cavity of the downstream hot-fluid header can be different from the fraction of the second fluid collected and diverted in the peripheral cavity of the upstream hot-fluid header, so as to adapt this quantity of second fluid collected at the temperature of the walls of the downstream hot-fluid header. In fact, since the downstream hot-fluid header is downstream of the heat exchanger body, the first fluid flowing into the downstream hot-fluid header, downstream of the heat exchanger body, exhibits a temperature necessarily lower than its temperature when passing into the upstream hot-fluid header.

In some embodiments, the upstream hot-fluid header is configured to collect a fraction of the first fluid at an upstream end of the upstream hot-fluid header, and to feed said fraction to the heat exchanger body at a downstream end of the upstream hot-fluid header by means of the peripheral cavity.

In this configuration, contrary to the embodiments described above, at the same time the first fluid flows into the main cavity and into the peripheral cavity, in the same direction of circulation. In other words, the first fluid is separated into a main central flow and a secondary peripheral flow. This configuration varies the temperature of the walls more progressively, and therefore reduces the thermal gradients. In particular, having a peripheral flow in the double wall, of a lower flow rate than the main flow, produces a lower exchange coefficient and therefore a lower thermal gradient within the walls.

It is evident that the upstream cold-fluid header, the downstream hot-fluid header, and the downstream cold-fluid header can also be equipped with a similar double wall, separating the respective flows into a main central flow and a secondary peripheral flow.

In some embodiments, the double wall comprises an internal wall delimiting the main cavity, and an external wall arranged around the internal wall, a gap between the internal wall and the external wall being between 1 and 10 mm.

The present disclosure also relates to an aircraft turbomachine comprising a heat exchanger device according to any one of the preceding embodiments.

### BRIEF DESCRIPTION OF THE DRAWINGS

The invention and its advantages will be better understood from the following detailed description of different embodiments of the invention given by way of non-limiting examples. This description makes reference to the pages of the attached figures, in which:

FIG. 1 schematically illustrates a sectional frontal view of a cross-current heat exchange device according to the prior art,

FIG. 2 schematically illustrates a perspective view of a cross-current heat exchange device according to a first embodiment,

FIG. 3 schematically illustrates a sectional frontal view of the heat exchange device of FIG. 2,

FIG. 4 schematically illustrates a sectional frontal view of a cross-current heat exchange device according to a second embodiment,

FIG. 5 schematically illustrates a sectional frontal view of a cross-current heat exchange device according to a third embodiment,

FIG. 6 schematically illustrates a sectional frontal view of a cross-current heat exchange device according to a fourth embodiment,

FIG. 7 schematically illustrates a sectional frontal view of a cross-current heat exchange device according to a fifth embodiment,

FIG. 8 schematically illustrates a sectional frontal view of a cross-current heat exchange device according to a sixth embodiment.

### DESCRIPTION OF EMBODIMENTS

In the disclosure below, the terms “upstream” and “downstream” are defined relative to the direction of flow of fluids in the different currents of the heat exchanger device, that is, “hot” and “cold” currents.

It is evident also that for the sake of clarity and comprehension the heat exchanger devices according to the different embodiments are illustrated schematically, the details of the real structure of such a device, for example the layout of internal channels of the heat exchanger body 30 not being illustrated.

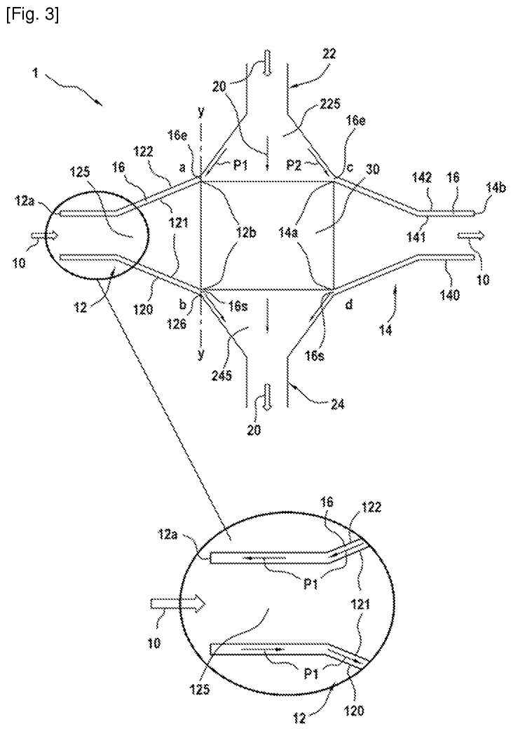

FIG. 2 shows a perspective view of a heat exchanger device 1 according to a first embodiment of cross-current type, and FIG. 3 schematically illustrates a frontal and sectional view of this device, comprising a first current 10 known as “hot current”, and a second current 20 known as “cold current”. In addition, according to this embodiment and the following also, the headers 12, 14, 22, 24 are conduits of rectangular cross-section. It is evident however that the invention is not limited to the headers of rectangular cross-section, and applies also to other forms, circular or elliptical for example.

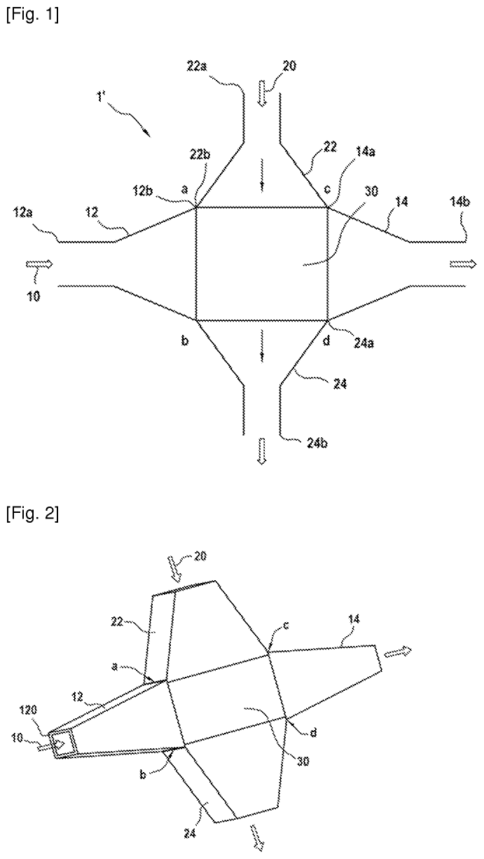

It is also evident that the invention is not limited to cross-current exchanger devices, but likewise applies to other types of exchangers such as co-current or counter-current exchangers. Also, apart from the double wall described hereinbelow, the other elements of the exchanger device 1 are identical to the exchanger device 1′ described earlier in reference to FIG. 1, and will not be repeated.

According to the present embodiment, the upstream hot-fluid header 12 comprises a double wall 120. More specifically, the double wall 120 comprises an internal wall 121 and an external wall 122 surrounding the internal wall 121.

The internal wall 121 delimits a main cavity 125 in which a main flow of a first fluid circulates, called “hot fluid” in the description below, from the upstream end 12a of the upstream hot-fluid header 12 to the downstream end 12b, so as to feed said hot fluid to the heat exchanger body 30. The external wall 122 is arranged around the internal wall 121, by being spaced apart from the latter by a distance of between 1 and 10 mm, for example. A peripheral cavity 16, surrounding the main cavity 125, is therefore formed between the internal wall 121 and the external wall 122 of the double wall 120.

In addition, at the downstream end 12b attached to the heat exchanger body 30, and in the region of the linear junction “a” between the upstream hot-fluid header 12, the upstream cold-fluid header 22, and the heat exchanger body 30, the upstream hot-fluid header 12 comprises an inlet section 16e which puts the peripheral cavity 16 in fluid communication with the main cavity 225 of the upstream cold-fluid header 22, wherein the second fluid circulates, called “cold fluid” in the description below.

Also, at the downstream end 12b attached to the heat exchanger body 30, and in the region of the linear junction “b” between the upstream hot-fluid header 12, the downstream cold-fluid header 24, and the heat exchanger body 30, the upstream hot-fluid header 12 comprises an outlet section 16s which puts the peripheral cavity 16 in fluid communication with the main cavity 245 of the downstream cold-fluid header 24, in which the cold fluid circulates downstream of the heat exchanger body 30. It is evident also that the peripheral cavity 16 is closed at the upstream end 12a of the upstream hot-fluid header 12.

The inlet section 16e is preferably of such a size that a portion P1 between 0.5 and 5% of the main flow of the current 20 of cold fluid flowing into the upstream cold-fluid header 22 is collected in the peripheral cavity 16. Consequently, as it flows into the upstream cold-fluid header 22, a portion P1 (shown by an arrow in FIG. 3) of the cold fluid does not enter the heat exchanger body 30, but is diverted to the peripheral cavity 16.

The enlarged image at the bottom of FIG. 3 schematically illustrates the trajectory (illustrated by arrows) of this portion P1 of the cold fluid in the peripheral cavity 16. Even though this figure is illustrated in a plan view, and arrows indicate a longitudinal flow of the cold fluid in the peripheral cavity 16, it is understood that the cold fluid does not flow only longitudinally between the ends 12a and 12b in one direction then in the other, but also flows around the main cavity 125, given the form of the peripheral cavity 16 seen especially in FIG. 2, at the end of the upstream hot-fluid header 12. In this way, the portion P1 of the cold fluid is diffused in at least part of the peripheral cavity 16, and is then reinjected into the downstream cold-fluid header 24 by means of the outlet section 16s.

It is evident that the flow of the portion P1 of the cold fluid, especially its collection via the inlet section 16e until its reinjection into the downstream cold-fluid header 24 via the outlet section 16s, can be realised by the set of differences in pressures and temperatures existing between the inlet section 16e and the outlet section 16s.

In addition, in this example, the downstream hot-fluid header 14 also comprises a double wall 140, comprising an internal wall 141 and an external wall 142 together forming a peripheral cavity 16. The peripheral cavity 16 is in fluid communication with the main cavity 225 of the upstream cold-fluid header 22 via an inlet section 16e, and with the main cavity 245 of the downstream cold-fluid header 24 via an outlet section 16s.

The inlet section 16e is arranged at the upstream end 14a attached to the heat exchanger body 30, in the region of the linear junction “c” between the downstream hot-fluid header 14, the upstream cold-fluid header 22, and the heat exchanger body 30, and the outlet section 16s is arranged at the upstream end 14a attached to the heat exchanger body 30, in the region of the linear junction “d” between the downstream hot-fluid header 14, the downstream cold-fluid header 24, and the heat exchanger body 30.

Consequently, in this example, a portion P2 (illustrated by an arrow in FIG. 3) of the cold fluid, which also can be between 0.5 and 5% of the main flow of the cold fluid, is collected and diverted to the peripheral cavity 16 of the downstream hot-fluid header 14, identically to the upstream hot-fluid header 12. It is evident that the inlet section 16e and the outlet section 16s of the downstream hot-fluid header 14 can be identical to the inlet section 16e and to the outlet section 16s of the upstream hot-fluid header 12, or different from the latter.

In an example of application of the heat exchanger device 1, a hot fluid, especially hot gases leaving a low-pressure turbine, at a temperature of 1000° C. can be collected at the inlet of the hot current 10, and a cold fluid, for example flowing in the secondary air flow path, at a temperature of 100° C. can be collected at the inlet of the cold current 20. In this case, the double walls 120, 140 of the hot-fluid headers lower the average temperature of their walls of the order of 300 to 500° C., this range depending on the thermal exchange properties of each of the two fluids (hot and cold) which are in contact with the walls. In this way, the walls of the hot-fluid headers are subject to a more reduced range of variation in temperatures during any given operation of the engine of the turbomachine due to the reduction in wall temperature of the hot-fluid headers 12, 14.

In particular, in the absence of double wall, the hot fluid headers can undergo a variation in temperature between 20° C. (ambient temperature prior to engine startup) and 1000° C. (temperature reached during operation of the engine). In the presence of double walls, this range can be reduced to the difference [20° C.-500° C.], by supposing a drop in maximal temperature of the internal wall 121, 141 by 500° C. due to heat exchanges with the cold fluid in the peripheral cavity 16. This accordingly reduces the thermal loads in the hot fluid headers and especially in the zones of the most sensitive junctions a, b, c and d, diminishes the risk of deformation of the headers and of leaks in the region of these junctions.

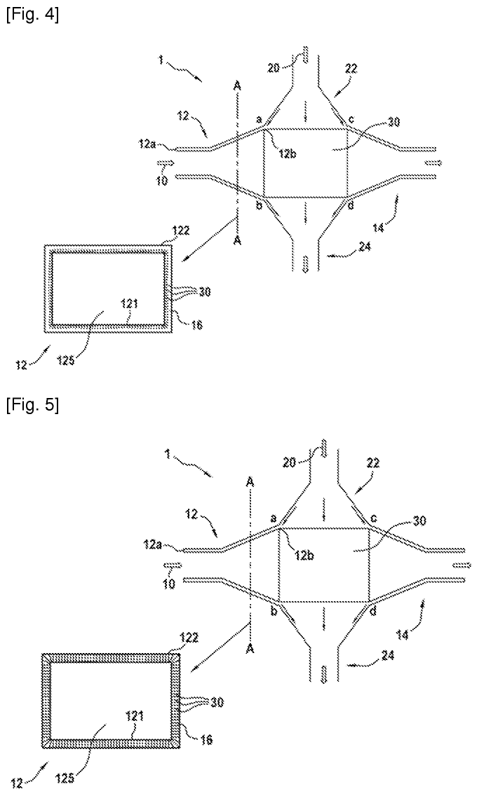

FIG. 4 schematically illustrates a heat exchanger device 1 according to a second embodiment. This heat exchanger device 1 differs from the heat exchanger device according to the first embodiment in that the upstream hot-fluid header 12 comprises a plurality of fins 30 arranged in the peripheral cavity 16.

As illustrated in the image in the lower left of FIG. 4, representing a section of the upstream hot-fluid header 12 in a sectional plan A-A, the fins 30 are walls extending vertically from and relative to the internal wall 121, for example, in other words perpendicularly to the latter, in the direction of the external wall 122, but without contact with the latter. The fins 30 also extend longitudinally, that is, from upstream to downstream, between the upstream end 12a and the downstream end 12b, over at least part of the length of the upstream hot-fluid header 12. The fins 30 are distributed preferably at regular intervals around a central axis of the header.

These fins 30 are arranged in the peripheral cavity 16 by being immersed in the fraction of the cold fluid flowing into said cavity, augmenting the exchange surface with the cold fluid and therefore heat transfers. It is evident that the downstream hot-fluid header 14, in this example comprising a double wall 140, can also comprise similar fins 30 in its peripheral cavity.

FIG. 5 schematically illustrates a heat exchanger device 1 according to a third embodiment. As illustrated in the image at the lower left of FIG. 5, representing a section of the upstream hot-fluid header 12 in a sectional view A-A, this heat exchanger device 1 differs from the heat exchanger device according to the second embodiment in that the fins 30 extend over the entire height of the space separating the internal wall 121 and the external wall 122.

In this configuration, the fins 30 extend longitudinally over only part of the length of the upstream hot-fluid header 12 between the upstream end 12a and the downstream end 12b, and not over the entire length of the latter so as to allow the fraction of the cold fluid collected by means of the inlet section 16e to flow in the peripheral cavity 16 and as far as the outlet section 16s.

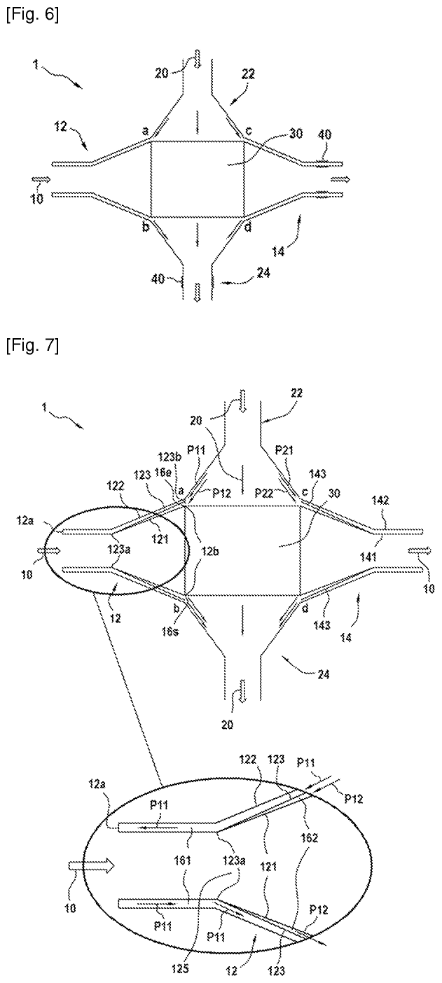

FIG. 6 schematically illustrates a heat exchanger device 1 according to a fourth embodiment. This heat exchanger device 1 differs from the heat exchanger device according to the first embodiment in that the downstream hot-fluid header 14 and the downstream cold-fluid header 24 comprise flexible sections 40. In this example, the flexible sections 40 are gussets arranged over a section of the headers 14, 24 and enabling longitudinal deformation of the latter by extending or retracting so as to absorb the dilations of the headers.

FIG. 7 schematically illustrates a heat exchanger device 1 according to a fifth embodiment. This heat exchanger device 1 differs from the heat exchanger device according to the first embodiment in that the upstream hot-fluid header 12 comprises an intermediate wall 123 arranged in the peripheral cavity 16, and separating the fraction of the cold fluid collected in the upstream cold-fluid header 22 into two fractions P11 and P12, resulting in a secondary external flow and a secondary internal flow in the peripheral cavity 16.

More specifically, the intermediate wall 123 divides the peripheral cavity 16 into an external peripheral cavity 161 in which the secondary external flow, that is, the portion of cold fluid P11 circulates, and an internal peripheral cavity 162 in which the secondary internal flow, that is, the portion of cold fluid P12 circulates. For this to occur, the intermediate wall 123 extends around the internal wall 121 and transversally to the latter so as to close off the internal peripheral cavity 162 at one of its ends. In other words, the end 123b of the intermediate wall 123 to the side of the downstream end 12b of the header 12 is arranged between the internal wall 121 and the external wall 122 so as to divide the inlet section 16e and the outlet section 16s into two, and the end 123a of the intermediate wall 123 closer to the upstream end 12a of the header 12 is in contact with the internal wall 121 by being attached to the latter so as to close off the internal peripheral cavity 162 at this end 123a.

In this example, the downstream hot-fluid header 14 also comprises an intermediate wall 143 similar to the intermediate wall 123, arranged between the internal wall 141 and the external wall 142, and separating the fraction P2 of cold fluid collected in two portions P21 and P22.

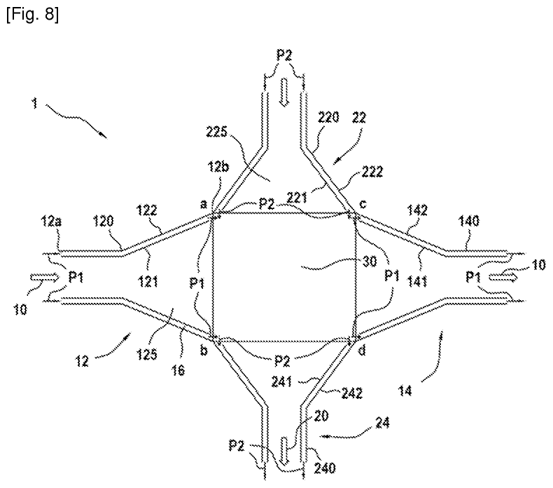

FIG. 8 schematically illustrates a heat exchanger device 1 according to a sixth embodiment. In this embodiment, contrary to preceding embodiments, the peripheral cavity 16 is not closed at the upstream end 12a of the upstream hot-fluid header 12, but open. In addition, at the downstream end 12b, the peripheral cavity 16 does not terminate in the main cavity 225 of the upstream cold-fluid header 22, but terminates in the main cavity 125 of the upstream hot-fluid header 12, opposite the heat exchanger body 30. In this way, according to this embodiment, a portion P1 of the main hot current 10 is diverted in the peripheral cavity 16 in the region of the upstream end 12a, and flows along the peripheral cavity 16, in the same direction of circulation as the main flow in the main cavity 125, as far as the downstream end 12b.

This portion P1 of the main hot current 10 then flows into the heat exchanger body 30. In this example, the downstream hot-fluid header 14 also comprises a double wall 140 similar to the double wall 120 of the upstream hot-fluid header 12, comprising especially an internal wall 141 and an external wall 142. A portion P1 of the main hot current 10 leaving the heat exchanger body 30 can therefore be diverted into the double wall 140 of the downstream hot-fluid header 14.

In this example also, the upstream cold-fluid header 22 comprises a double wall 220 having an internal wall 221 and an external wall 222, and the downstream cold-fluid header 24 comprises a double wall 240 having an internal wall 241 and an external wall 242. In this way, in the same way as for the double walls of the upstream and downstream hot fluid headers, a portion P2 of the main cold current 20 can be collected at the upstream end of the upstream cold-fluid header 22, can flow along the peripheral cavity of the latter as far as the heat exchanger body 30, and then can be reinjected into the peripheral cavity of the downstream cold-fluid header 24.

It is clear that as opposed to the preceding embodiments in which the headers equipped with a double wall are attached to the heat exchanger body 30 by means of their internal wall 121, 141, the headers of the heat exchanger device 1 according to the sixth embodiment are attached to the heat exchanger body 30 by means of their external wall 122, 142, 222, 242. In this way, whereas in the preceding embodiments, the peripheral cavity 16 of the upstream hot-fluid header 12 terminates in the main cavity 225 of the upstream cold-fluid header 22, the peripheral cavity 16 of the upstream hot-fluid header 12 according to the sixth embodiment terminates on the heat exchanger body 30.

It is also evident that in the different embodiments one to six described earlier the heat exchanger body 30 and the different headers making up the heat exchanger device 1 can be separate pieces assembled and connected to each other by welding or by brazing for example, or can be manufactured monobloc, by additive manufacturing for example.

Even though the present invention has been described in reference to specific exemplary embodiments, it is evident that modifications and changes can be made to these examples without departing from the general scope of the invention such as defined by the claims. In particular, individual characteristics of the different illustrated/mentioned embodiments can be combined into additional embodiments. Consequently, the description and the drawings are to be considered in an illustrative rather than a restrictive sense.

1. A heat exchanger device for aircraft turbomachine, comprising a heat exchanger body, an upstream hot-fluid header attached to the heat exchanger body and configured to collect a first fluid at a first temperature and to feed it to the heat exchanger body, an upstream cold-fluid header attached to the heat exchanger body and configured to collect a second fluid at a second temperature lower than the first temperature and to feed it to the heat exchanger body, at least the upstream hot-fluid header comprising a double wall forming a peripheral cavity surrounding a main cavity configured to receive a main flow of the first fluid, the peripheral cavity being configured to receive a secondary flow formed by a fraction of the first fluid or of the second fluid.

2. The device according to claim 1, comprising a downstream cold-fluid header attached to the heat exchanger body and configured to collect the second fluid flowing from the heat exchanger body, the fraction being a fraction of the second fluid flowing into the upstream cold-fluid header, the upstream hot-fluid header being configured to collect said fraction of the second fluid, and to feed said fraction to the downstream cold-fluid header by means of the peripheral cavity.

3. The device according to claim 2, wherein the peripheral cavity comprises at least one inlet section opening in a main cavity of the upstream cold-fluid header, the inlet section being configured to collect the fraction of the second fluid and being arranged at a first junction between the upstream cold-fluid header, the upstream hot-fluid header and the heat exchanger body.

4. The device according to claim 2, wherein the peripheral cavity comprises at least one outlet section opening in a main cavity of the downstream cold-fluid header, the outlet section being configured to inject the fraction of the second fluid flowing into the peripheral cavity into the downstream cold-fluid header, and being arranged at a second junction between the downstream cold-fluid header, the upstream hot-fluid header and the heat exchanger body.

5. The device according to claim 1, wherein the upstream hot-fluid header comprises fins extending on the one hand longitudinally in a direction of flow of the first fluid in the main cavity, and extending on the other hand from one of the two walls of the double wall to the other of the two walls, inside the peripheral cavity.

6. The device according to claim 5, wherein the fins extend on the one hand longitudinally over a portion of a length of the upstream hot-fluid header, and extend on the other hand over the entire height of a space separating the two walls of the double wall.

7. The device according to claim 1, wherein the upstream hot-fluid header comprises an intermediate wall arranged in the peripheral cavity, and separating the fraction of the second fluid collected in the upstream cold-fluid header into a secondary internal flow and a secondary external flow.

8. The device according to claim 1, wherein the fraction of the second fluid collected in the upstream cold-fluid header is between 0.5 and 5% of the flow rate of the second fluid flowing into the upstream cold-fluid header.

9. The device according to claim 1, comprising a downstream hot-fluid header attached to the heat exchanger body, configured to collect the first fluid flowing from the heat exchanger body, comprising a double wall forming a peripheral cavity, and configured to collect a fraction of the second fluid flowing into the upstream cold-fluid header, and to feed said fraction to the downstream cold-fluid header by means of said peripheral cavity.

10. The device according to claim 1, wherein the fraction is a fraction of the first fluid, the upstream hot-fluid header being configured to collect said fraction of the first fluid at an upstream end of the upstream hot-fluid header, and to feed said fraction to the heat exchanger body at a downstream end of the upstream hot-fluid header by means of the peripheral cavity.

11. The device according to claim 1, wherein the double wall comprises an internal wall delimiting the main cavity, and an external wall arranged around the internal wall, a gap between the internal wall and the external wall being between 1 and 10 mm.

12. An aircraft turbomachine comprising a heat exchanger device according to claim 1.
